(19) United States
(12) Patent Application Publication
(10) Pub. No.: US 2013/0209176 A1
(43) Pub. Date: Aug. 15, 2013

(54) MIXTURE TO BE APPLIED ONTO A DUMP OF RESIDUE SALT

(71) Applicants: Hans-Joachim Kind, Hohenwarthe (DE); Albrecht Palm, Garlipp (DE); Martin Westphal, Wolmirstedt (DE)

(72) Inventors: Hans-Joachim Kind, Hohenwarthe (DE); Albrecht Palm, Garlipp (DE); Martin Westphal, Wolmirstedt (DE)

(73) Assignee: K+S KALI GMBH, Kassel (DE)

(21) Appl. No.: 13/700,388

(22) PCT Filed: May 18, 2011
(86) PCT No.: PCT/DE11/01083

§ 371 Date: Jan. 25, 2013

(30) Foreign Application Priority Data
May 27, 2010 (DE) 102010021675.5-44

(51) Int. Cl. C09K 17/10

(52) U.S. Cl. CPC C09K 17/10
USPC 405/266

(57) ABSTRACT

The invention relates to a mixture to be applied onto a dump of residue salt as an infiltration-inhibiting layer for reducing the occurrence of pile water caused by precipitation, wherein the mixture comprises residue salt and a mineral additive which is poorly soluble to insoluble and has hydraulically and/or pozzolanically setting properties.

The invention relates to a mixture to be applied onto a dump of residue salt, for instance in the potash industry, a method for covering dumps of residue salt, as well as a dump of residue salt with a covering (infiltration-inhibiting layer).

During processing of raw salts, for instance for potash production, residues accumulate, which consist substantially of salt. Unless it is disposed of in another manner, this residue is dumped. In order to occupy as little ground area as possible and to expose as little surface as possible in relation to the volume of the dump to precipitations, the dumps are preferably built in the shape of a truncated cone with steep slopes. Many dumps have a seal at their base in order to prevent the pile waste water from seeping away into the ground. The dumps are usually bordered by ditches in order to receive and discharge the accumulating pile water in an orderly fashion, the amount of pile water depending i.a. on the amount of precipitation.

The amount of accumulating pile water must be kept as small as possible. In this respect, different methods for covering dumps for the purpose of grassing-over and land reclamation are already known from the prior art. The whole purpose of such a covering is to always provide a steady covering with a great variety of materials that prevents as much as possible precipitation water from penetrating into the body of the dump, thereby causing dissolution processes and forming the previously mentioned pile water.

In this context, completely covering dumps with a setting layer is known from DE-PS 39 25 953. This layer hereby consists for the most part of calcium sulfate. A thin layer of soil and biomass is then added to such a covering in order to allow for grassing-over.

Adding a filter ash cement suspension to dumps in order to seal off their surface is also known from DE-PS 4 117 270.

Applying excavated soil and construction waste as a covering layer is furthermore known from DE-PS 43 37 730. Hereby, a contact layer consisting of coarse-grained material is first applied onto the dump and the excavated soil and construction waste are applied as a mixture onto this contact layer in a second step.

A dump covering consisting of hydraulically and/or pozzolanically setted mixtures of mineral residue is described in DE-PS 196 32 154. The residues comprise more specifically ashes from the combustion of sludge, biomass and wood and/or gypseous residues. These mixtures of materials are applied in several layers onto the surface of the dump in the form of a moistened mass starting at the foot of the dump and compacted toward the inner side of the dump.

It is known that due to the behavior of the dump body (e.g. viscoplasticity, solubility and remineralization), salt dumps are difficult to cover.

A dump covering for dumps of residue salt i.a. is known from DE 199 37 270 A1 in which a rolling, crumbly green granulate is applied on the dump. The green granulate comprises saline slags from aluminum production as well as hardenable power plant ashes. Based on an average thickness of the covering of ca. 15 m, approximately 20 t/m² of green granulate are required in order to cover a salt dump. In individual cases, the covering can have a thickness of 5 to 25 m. Hereby it is advantageous that from the day of the application, the proportion of pile water is significantly reduced. The disadvantage is the amount of required cover material as well as having to ensure the quality of the cover material, more specifically regarding its physical and biological properties. In order to be able to cover all the salt dumps in Europe with the previously described cover material, amounts would be required that would not even be available in centuries.

Therefore, the object underlying the invention is to ensure in a simple and inexpensive manner that the infiltration of precipitation water into the dump itself is permanently hindered with the objective of reducing the accumulation of pile water.

In order to solve the object, the invention proposes a mixture to be applied on a dump of residue salt, which is characterized in that the mixture comprises residue salts corresponding to the dump material as well as at least one mineral additive, which is poorly soluble to insoluble and has hydraulically and/or pozzolanically setting properties.

The core of the invention therefore consists in mixing a mineral additive, which is poorly soluble to insoluble and has hydraulic and/or pozzolanic properties with the residue salt, the mixture being then deposited onto the dump in the exact same manner as the residue salt itself.

Due to the fact that the mixture consists of the at least one additive with the hydraulically and/or pozzolanically setting properties and of the residue salt, the falling precipitation water is at first substantially completely absorbed by the mixture. The dissolution processes are hereby slowed. This is because due to the pozzolanically and/or hydraulically setting properties of the additive, the water is proportionately absorbed. In the course of time, leaching processes occur in the area of the dump surface, with the consequence that a surface (infiltration-inhibiting layer) is formed “sui iuris”, which substantially consists of insoluble components. This layer consisting substantially of insoluble components can regenerate itself. From this it follows that this layer accumulates over the years. Such a covering that continuously regenerates is steady and secured against deformation. The consequence of this is that if plant nutrients are applied onto the dump such a layer grasses over by itself.

Due to such a covering with a mixture of the dump residue and the additive, the infiltration of precipitation water is reliably inhibited. This means that the layer works as an infiltration-inhibiting layer. This infiltration-inhibiting layer durably supports the retention and evaporation of precipitation water and thereby inhibits the infiltration of the precipitation and with it the proportion of water in the pile. It must however be assumed that a certain part of the precipitation infiltrates the body of the dump, thus counteracting the residue-specific viscoplastic deformations. This means that the covering is able to adapt to the dump-specific deformations as they occur in the course of time.

In addition to a significant reduction of the dump wastewater, another advantage is that residue salt can be dumped again onto an already covered dump. This means that despite having been closed, such a dump can still be developed as opposed to a dump covered according to the prior art of DE 199 37 270 A1. The reason for this is that the desalinated covering layer has the same physical properties than the residue salt. This means that the slope angle does not change even in case of new deposition; due to the same slope angle, the steadiness is thereby ensured.

It is moreover advantageous that in the course of regular stockpiling operations, the covering material can be applied as required, i.e. the dump of residue salt can even be partially covered during piling of the residue salt, which means that the proportion of dump water is correspondingly reduced during the ongoing piling process. Therefore, during processing of the raw salt the disposal is ensured in any case.

Another advantage consists in that the chemical composition of the dump water is not changed by the covering according to the invention; in this respect the existing disposal procedures can be maintained.

Advantageous features can be gathered from the sub-claims.

It is thus more specifically provided that the additive is available in a silty to clayey form. In connection with pozzolanic and/or hydraulic properties they are able to chemically bond free pore water, so-called free residual humidity, in the residue salt. Hereby, ashes from the combustion of fossil fuels, more specifically from brown coal combustion, as well as residue from the processing of substances from heat treatment and combustion processes can be used. Furthermore, clay and/or gypsum can be used. A mixture of additives composed of the components mentioned above is also an object of the invention.

The choice of the additive and thus of the mixture of solid fractions depends i.a. on the composition of the residue and on the climatic conditions and more specifically depends on the average amount of precipitation per year. However, the exposure of the surface of the dump that is covered is also important. It must more specifically be taken care that, if necessary, the weather side has a layer with a greater thickness than the slope of the dump that is on the side facing away from the weather.

According to a particularly advantageous feature of the invention, the proportion of additive in the mixture as a whole amounts to 1-10 mass percent, preferably 3 to 7 mass percent. These values result in a surface of the dump that reliably hinders the infiltration of surface water after a short time.

Moreover, it is provided that the additive, respectively the individual components of the additive are available as particles.

A method for covering dumps of residue salt or parts of dumps of residue salt with a mixture of the type described above is also an object of the invention. Mixing the residue salt and the additive, respectively the components of the additive can hereby occur before the actual deposition process onto the salt dump but also during the deposition process.

A dump of residue salt characterized by a covering with a mixture of the type described above is also an object of the invention. Hereby, it is provided that the mixture is applied onto the dump with a thickness of several meters. With a thickness of several meters it doesn't matter if local erosion occurs or if fissures are formed, since the infiltration-inhibiting layer continuously reforms “sui iuris” in the course of the continuously occurring dissolution processes. This means that a dump covered in such a manner has a self-healing ability and is substantially maintenance free with respect to the surface covering. Such an infiltration-inhibiting layer, which is formed by applying the mixture according to the invention, moreover does not require any additional space in the foreland of the dump, since the proportion of 1% to 10% of the additive carries no weight with respect to the amount of residue salt.

The addition of the additive to the residue does not change the mechanical properties of the residue, i.e. the repose angle does not change. The mixture can therefore be applied to slopes and plateaus typical of residue dumps.

It has been discovered for example that when adding 5 mass % of insoluble additives with the properties mentioned above, such as for instance ash and gypsum, to the residue salt, with an average annual precipitation of 600 mm, an infiltration-inhibiting layer with a thickness of ca. 8 mm is formed every year. Due to the properties of the insoluble solids and their interactions with the residue material and to the humidity of the residue material, the infiltration-inhibiting layer has a durable stability and steadiness. Potential erosions in exposed locations, for example caused by water on very steep slopes or by wind on edges, are renewed in the course of the continuously occurring dissolution processes. The efficiency of the infiltration-inhibiting layer with regard to storage capacity and to support of the evaporation increases along with the growth of the thickness of the layer. In the course of its long lasting development, as a consequence of climatic influences and accumulation of plant nutrients, the infiltration-inhibiting layer traverses a transformation process that is virtually similar to the soil formation process and that favors the settlement of adapted plants

In the following, the invention will be described more closely based on an example. In the drawings:

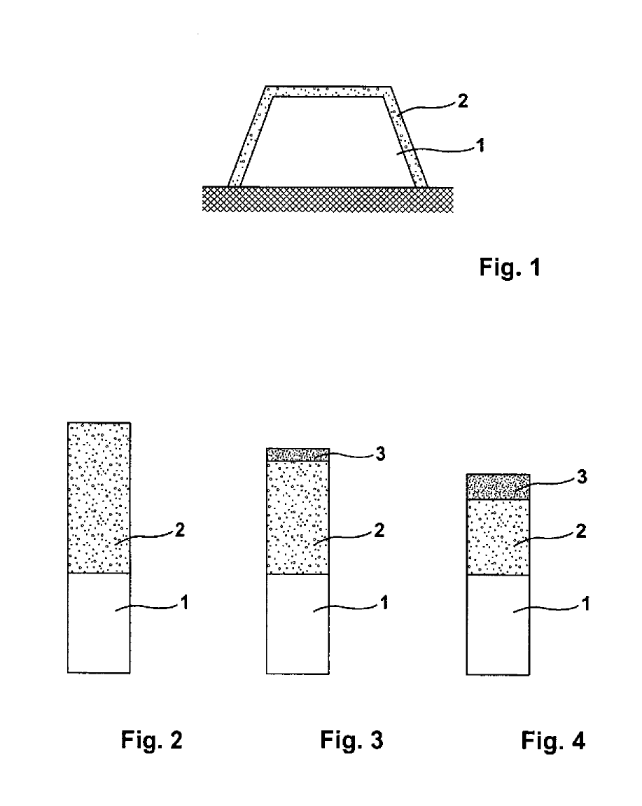

FIG. 1 schematically shows a dump of residue

FIG. 2 shows a fresh dumping with the mixture according to the invention;

FIG. 3 shows the early formation of an infiltration-inhibiting layer due to dissolution and accumulation caused by precipitation after approximately 1 to 3 years;

FIG. 4 shows an infiltration-inhibiting layer according to FIG. 3 in the fourth year.

FIG. 1 schematically shows a dump of residue salt, the actual dump material being labeled 1 and the mixture according to the invention with its thickness of approximately 10 m applied onto the dump being labeled 2.

Immediately after applying the mixture according to the invention, this layer acts in an infiltration-inhibiting manner, as can be seen in FIG. 2. In the course of time, precipitation causes a dissolution and leaching on the surface of the mixture according to the invention. This emerging infiltration-inhibiting layer labeled 3 in FIG. 3 is characterized in that due to dissolution and leaching processes it substantially only consists of insoluble parts. This infiltration-inhibiting layer 3 which forms “sui iuris” is subjected to a growth of ca. 0.8 to 1 cm per year. This means that it becomes thicker in the course of time. In the fourth year, it has a thickness of >3 cm, with the thickness continuing to increase over the years. From the representation according to FIGS. 2 to 4, it also becomes clear that the infiltration-inhibiting layer is able to regenerate on its own over time. For example, if fissures form in the surface of the infiltration-inhibiting layer 3, the subjacent layer 2 that substantially corresponds to the original mixture of the covering material will again form a layer, due to leaching and dissolution processes, which, as an infiltration-inhibiting layer, at least inhibits the infiltration of precipitation water.

1. A mixture to be applied onto a dump of residue salt for reducing the occurrence of pile waste water caused by precipitation, wherein
the mixture comprises residue salt and a mineral additive, which is poorly soluble to insoluble and has hydraulically and/or pozzolanically setting properties.

2. The mixture according to claim 1, wherein
the additive is predominantly available in a silty to clayey form.

3. The mixture according to claim 1, wherein
ash from the combustion of fossil fuels is used as an additive.

4. The mixture according to claim 1, wherein
processes are used as an additive.

5. The mixture according to claim 1, wherein
clay and/or gypsum is used as an additive.

6. The mixture according to claim 1, wherein
the proportion of the additive as a second solid fraction in addition to the residue salt relative to the entire solid content of the mixture amounts to 1 to 10 mass %.

7. The mixture according to claim 1, wherein
the friction angle of the mixture of the additive and the residue salt corresponds approximately to the friction angle of the residue salt.

8. A method for covering dumps of residue salt or parts of dumps of residue salt, wherein
a mixture according to claim 1 is used.

9. The method according to claim 8, wherein
the residue salt is mixed with the additive before the deposition process of the mixture onto the dump.

10. The method according to claim 8, wherein
the mixing of the residue salt with the additive occurs during the deposition process onto the dump.

11. A dump of residue salt,
characterized by
a covering with a mixture according to claim 1.

12. The dump of residue salt according to claim 11, wherein
the mixture is overlaid onto the dump with a thickness of several meters.
